(19) United States
(12) Patent Application Publication
(10) Pub. No.: US 2006/0265749 A1
(43) Pub. Date: Nov. 23, 2006

(54) Method for removing viruses infecting memory, computer-readable storage medium recorded with virus-removing program, and virus-removing apparatus

(76) Inventors: Seok-Chul Kwon, Seoul (KR); Won-Hyok Choi, Seoul (KR)

Correspondence Address: PERKINS COIE LLP, P.O. BOX 2168, MENLO PARK, CA, 94026, US

(21) Appl. No.: 10/552,941

(22) PCT Filed: May 20, 2003
(86) PCT No.: PCT/KR03/00992

§ 371 Date: Aug. 2, 2006

(30) Foreign Application Priority Data
Apr. 14, 2003 (KR) 10-2003-0023481

(51) Int. Cl. G06F 12/14

(52) U.S. Cl. 726/24

(57) ABSTRACT

Disclosed is a method for removing computer viruses including the steps of, if a function to be used to search information about areas infectable by viruses has been changed, restoring the function to be in a normal state thereof, and carrying out a procedure for scanning of infection and a disinfection procedure for processes residing in a memory and associated files scanned using a normal function. In accordance with this method, it is possible too completely and accurately scan information about areas infectable by viruses, in particular, all processes residing in the memory, and to completely remove viruses infecting the memory.

### TECHNICAL FIELD

The present invention relates to a method for detecting viruses from files stored in a computer or processes running in the computer, and disinfecting the files or processes infected by viruses, a computer-readable storage medium recorded with a virus-removing program, and a virus-removing apparatus. In particular, the present invention relates to a method, storage medium and apparatus capable of completely and accurately scanning information about areas infectable by viruses, in particular, all processes and threads residing in the memory, and completely removing viruses infecting the memory.

### BACKGROUND ART

When a program runs in a computer, its process resides in a memory of the computer. Generally, infection targets of viruses are such a memory-resident process, and program files stored in a storage device such as a hard disk. Since one virus-infected process may infect another process, viruses may be propagated.

An example of conventional methods for removing viruses infecting a memory will be described hereinafter.

First, a list of processes residing in the memory is scanned to determine whether or not files associated with the memory-resident processes have been infected by viruses. When it is determined that there is an infected file, the memory-resident process associated with the infected file is killed. Thereafter, the infected file stored in a hard disk is disinfected. After the disinfection, the disinfected file is again run, so that its normal process resides in the memory.

However, recent viruses are designed to be preferentially run when a vaccine program scans areas infectable by viruses, so that they are omitted from the scanned result, as if they were not present in the scanned areas.

Thus, processes infected by viruses among memory-resident processes are not scanned. For this reason, such conventional methods have a problem in that it is impossible to reliably detect viruses using vaccine programs thereof.

Furthermore, it is impossible to reliably detect viruses infecting only processes without infecting any files in accordance with conventional techniques. In addition, even where only a thread running on a memory, dependently upon a running process, is infected, it is impossible to determine whether or not the memory is infected by viruses.

### DISCLOSURE OF THE INVENTION

The present invention has been made in view of the above mentioned problems involved with conventional techniques, and an object of the invention is to provide a method capable of completely and accurately scanning information about areas infectable by viruses, in particular, all processes and threads residing in the memory, and completely removing viruses infecting the memory.

Another object of the invention is to provide a computer-readable storage medium recorded with a program for executing the above virus-removing method.

Another object of the invention is to provide a virus-removing apparatus including a hardware device applicable to personal computers (PCs), personal digital assistant (PDA), mobile phones, semiconductor manufacturing equipment, and other industrial appliances.

Definition of Terms

Virus: This is a type of program which modifies a computer program or executable parts thereof without the user's knowledge, and copies itself or the modified program parts into another computer program. Generally, such a virus means a small-capacity program for carrying out replication, infection, and destruction tasks. Any types of such a virus and any types of viruses creatable in the future may be within the range of viruses to which the technical idea of the present invention is applicable.

Area infectable by viruses: Generally, the area injectable by viruses is a storage device. Such a storage device includes both the main storage device and the auxiliary storage device. That is, this injectable area means all targets generally injectable by viruses. Such an injectable area may include memories, files, services, registries, TCP/IP packet ports, boot sectors, etc.

Operating system: This means a program which performs a function of interfacing the human user with a machine to provide convenience to the user by efficiently managing and operating limited system resources. Such an operating system includes DOS, Macintosh, Windows, OS/2, Unix, Linux, etc.

‘Function’ to be used to search information about areas infectable by viruses: This is a function provided by the operating system. Such a function includes API (Application Program Interface), system calls, etc.

Process: This means an independently executable unit of a program.

Process kill: This means ending of a process, that is, removal of the process from a memory.

In accordance with one aspect, the present invention provides a method for removing computer viruses comprising the steps of:

(A) if a function to be used to search information about areas injectable by viruses has been changed, restoring the function to be in a normal state thereof; and

(B) carrying out a procedure for scanning of infection and a disinfection procedure for processes residing in a memory and associated files scanned using a normal function.

The procedure for determination of infection and the disinfection procedure at the step (B) may be further carried out for thread areas of the memory.

In accordance with another aspect, the present invention provides a computer-readable storage medium recorded with a program for executing the steps of:

(A) if a function to be used to search information about areas infectable by viruses has been changed, restoring the function to be in a normal state thereof; and

(B) carrying out a procedure for scanning of infection and a disinfection procedure for processes residing in a memory and associated files scanned using a normal function.

Now, the present invention will be described with reference to the annexed drawings, in conjunction with Windows which is a representative operating system. However, the present invention is not limited to Windows. That is, it will be readily appreciated by those skilled in the art that the present invention is applicable to other similar operating systems.

### BRIEF DESCRIPTION OF THE DRAWINGS

The above objects, and other features and advantages of the present invention will become more apparent after a reading of the following detailed description when taken in conjunction with the drawings, in which:

FIG. 1 is a schematic view illustrating a method for disinfecting a process infected by viruses in accordance with the present invention;

FIG. 2 is a schematic view illustrating a method for scanning and removing viruses present in thread areas in accordance with the present invention;

FIG. 3 is a flow chart illustrating a method for disinfecting a process infected by viruses in accordance with a first aspect of the present invention;

FIG. 4 is a flow chart illustrating a method for disinfecting a process and a thread infected by viruses in accordance with a second aspect of the present invention;

FIG. 5 is a flow chart illustrating a method for disinfecting a process and a thread infected by viruses in accordance with a third aspect of the present invention;

FIG. 6 is a flow chart illustrating a method for disinfecting a process infected by viruses in accordance with a fourth aspect of the present invention;

FIG. 7 is a block diagram illustrating a virus-removing apparatus according to an embodiment of the present invention; and

FIG. 8 is a block diagram illustrating a virus-removing apparatus according to another embodiment of the present invention.

### BEST MODES FOR CARRYING OUT THE INVENTION

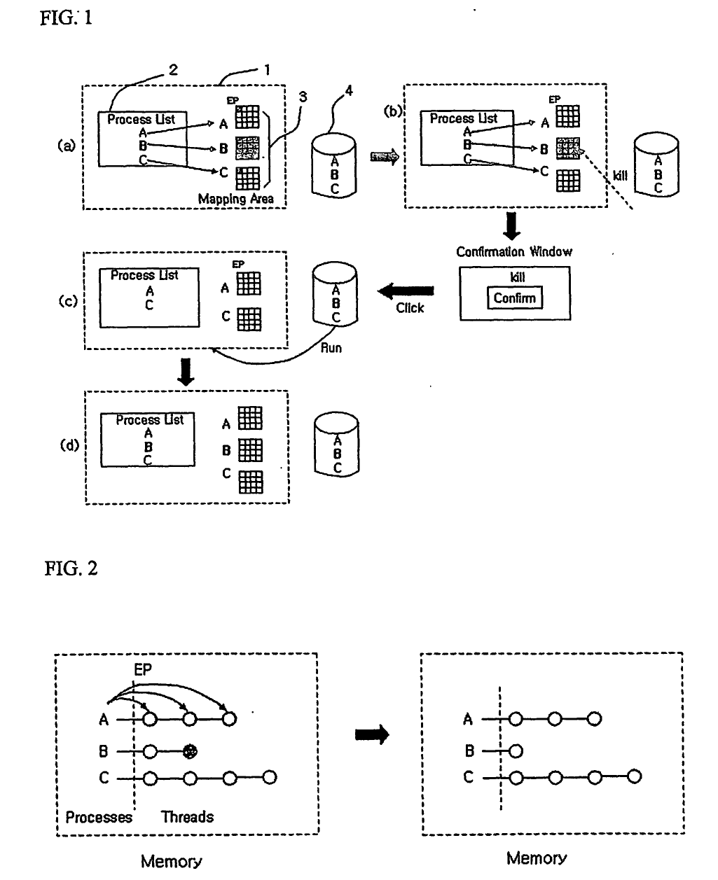

FIG. 1 is a schematic view illustrating a method for disinfecting a process infected by viruses in accordance with the present invention. In FIG. 1, reference numeral 1 denotes a memory, reference numeral 2 denotes a process list, and reference numeral 3 denotes process areas mapped with the process list 2. Also, reference numeral 4 denotes a storage device.

The present invention will be described hereinafter in conjunction with, for example, the disinfecting method shown in FIG. 1. First, the process list 2 and entry points EP of processes A to C are searched for in the memory 1. And, the searched processes are scanned to check whether or not each of the processes has been infected by viruses (a). Where one of the processes, for example, the process B, has been so damaged as not to be restorable, this damaged process is killed on the process area 3. In this case, the killing of the damaged process is preferably confirmed through a confirmation window prior to the execution thereof. After the process killing, the file of the process B is searched from the storage device 4 (b). Virus scanning and removal operations are then carried out for the searched file of the process B. Subsequently, the disinfected file of the process B is again executed (c). In accordance with this procedure, the disinfected process B resides in the memory 1 (d).

The routine of the disinfecting method may be ended without re-execution of the disinfected file B at step c. However, the following description will be given in conjunction with the case involving re-execution of a disinfected file, which may be a most preferable case.

Most vaccine programs use an API to search information about areas infectable by viruses.

The virus-removing method according to the present invention includes a procedure for previously storing binary codes of API functions not infected by any virus so that those binary codes are used to check whether or not the binary codes of respective API functions are normal. Preferably, the storage of binary codes of API functions is conducted in association with respective operating systems.

Accordingly, the vaccine program can compare the binary code of each API function to be used for searching information about areas injectable by viruses with the previously stored binary code of the API function, thereby checking whether or not the binary code is normal.

Examples of API functions used by the vaccine program to search information about areas injectable by viruses are as follows:

NTDLL.DLL::NtQuerySysteminformation

NTDLL.DLL::NtResumeThread

NTDLL.DLL::LdrGetDllHandle

KERNEL32.DLL::FindFirstFileExW

KERNEL32.DLL::FindNextFileW

ADVAPI32.DLL::Enum ServicesStatusA

ADVAPI32.DLL::Enum ServicesStatusW

ADVAPI32.DLL::RegEnumKeyExW

ADVAPI32.DLL::RegEnumKeyW

IPHLPAPI.DLL::GetTcpTableFromStack

IPHLPAPI.DLL::GetUdpTableFromStack

For example, where the function “NTDLL.DLL:: NtQuerySysteminformation” used in WinXP is infected by a virus, its code, which resides in the memory, may be changed as follows. The code, which is a bracketed portion in the following function, may vary depending on the operating system.

| B8{AC 00 00 00} mov | | | E9{6C 13 FD FF} jmp | |
|---|---|---|---|---|
| eax, Ach | | | OFFFD1371 | |
| BA 00 03 FE 7F mov edx, | | → | BA 00 03 FE 7F mov edx, | |
| 7FFE0300H | | | 7FFE0300h | |
| FF D2 | call edx | | FF D2 | call edx |
| C2 10 00 | retn 10h | | C2 10 00 | retn 10h |

Under the condition in which such a code change is made in the API function, the virus is preferentially run prior to normal execution of the API function, so that it prevents the information about the area, where it is present, from being included in the result of the API function. Accordingly, it is impossible to check infection of viruses, using only the result of the API function.

In order to solve this problem, the code of each normal API function is previously stored in the vaccine program or storage device (for example, the hard disk) in accordance with the present invention. This stored code is subsequently compared with the code of a corresponding API function to be used to search information about areas injectable by viruses, so that it is possible to check whether or not the latter code is normal.

Although the vaccine program may be infected by viruses residing in the memory in the comparison procedure, it can be disinfected in accordance with a method disclosed in Korean Patent No. 0370229 issued to the applicant.

When it is determined based on the result of the code comparison that there is no code change in the API function, processes residing in the memory are scanned based on the API function, and subjected to a disinfection procedure. Where it is desired to check and disinfect thread areas of the memory, it may be possible to search the thread areas, based on the API function, prior to the scanning of processes, and to subsequently perform scanning and disinfecting procedures therefor.

On the other hand, when it is determined based on the result of the code comparison that there is a code change in the API function, it is impossible to scan processes infected by viruses. In this case, accordingly, the code-changed API function is restored using the previously stored code. Thereafter, processes or thread areas are scanned based on the restored API function, and subjected to a disinfection procedure.

Through the above procedure, the API function maintains its integrity. In the above mentioned procedure, all API functions usable to search information about areas injectable by viruses are previously stored. However, it may be possible to previously store only the API functions to be used to search processes residing in the memory.

Meanwhile, there may be viruses of a type infecting only the process area of the memory without infecting the file area (for example, CodeRed or Slammer). For removal of viruses of such a type, it is necessary to scan the process area of the memory.

In this case, a list of processes residing in the memory and respective entry points (EP) of the processes are first searched for, using an API function. The API function may be NTDLL.DLL:: NtQuerySysteminformation or NTDLL.DLL::LdrGetDllHandle.

Next, the memory page is scanned, starting from the entry point of the associated process, thereby checking whether or not the associated process has been infected by viruses. Where the process has been infected by viruses removable by the vaccine program, these viruses are directly removed using the vaccine program.

Where the process residing in the memory has been severely damaged by viruses, it is killed because its disinfection is impossible. For example, where processes A, B, and C reside in the memory, and the process B is so damaged as not to be restorable, this process B is processed to be killed (refer to FIG. 1).

In this case, a message for confirming the killing of the B process is preferably displayed, prior to the execution of the killing procedure, so as to allow the user to confirm the killing of the B process. The reason why the message is displayed is to prevent the process B, which is currently running, from being optionally ended by the vaccine program, thereby preventing the contents of a task processed by the process B from disappearing, and to allow a user time to store the task in response to the message.

When the user clicks a confirm button associated with the message, the process B is processed to be killed.

Thereafter, a file corresponding to the infected process is searched for in the storage device (for example, the hard disk). In the case of FIG. 1, the file corresponding to the process B is searched for in the storage device.

When no corresponding file is searched for in the hard disk, the vaccine program is ended.

On the other hand, when there is a file corresponding to the infected process in the hard disk, this file is scanned to determine whether or not it has been infected by viruses. Where the file has been infected, it is disinfected. If necessary, the scanning and disinfecting procedure may also be carried out for the thread areas of the memory. This procedure will be described hereinafter.

After the disinfection of the file stored in the storage device, this file is preferably again executed. As the file is again executed, the process B not infected by any virus can reside in the memory. Thus, complete removal of viruses is achieved. The reason why the process B preferably resides in the memory is that if the process B is adapted to be used by the operating system, the operating system then may be abnormally operated under the condition in which the process B is killed.

Although the process B is again run, the corresponding file stored in the storage device is not infected because the associated damaged process has already been killed.

In addition to the process areas, the memory has thread areas separate from the process area. Viruses infecting such thread areas (for example, Elkern) mainly serve to add an infected thread to the thread areas of respective processes, thereby infecting the thread areas.

Accordingly, such viruses can be removed without interfering with the processes, which are currently run, by killing the added thread.

FIG. 2 is a schematic view illustrating a method for scanning and removing viruses present in thread areas in accordance with the present invention. In order to scan and remove viruses present in thread areas, it is first necessary to search for a list of threads respectively associated with processes residing in the memory, and respective entry points of the threads. The thread list and the entry point of each thread can be searched for, using an API function (for example, NTDLL.DLL::NtResumeThread), as in the above described method.

Next, the memory page is scanned, starting from the entry point of the associated thread, thereby checking whether or not the associated thread has been infected by viruses. Where there is a thread infected by viruses (corresponding to a dark thread in FIG. 2), this thread is killed to be removed from the memory. Accordingly, it is possible to remove viruses without killing the processes being currently run.

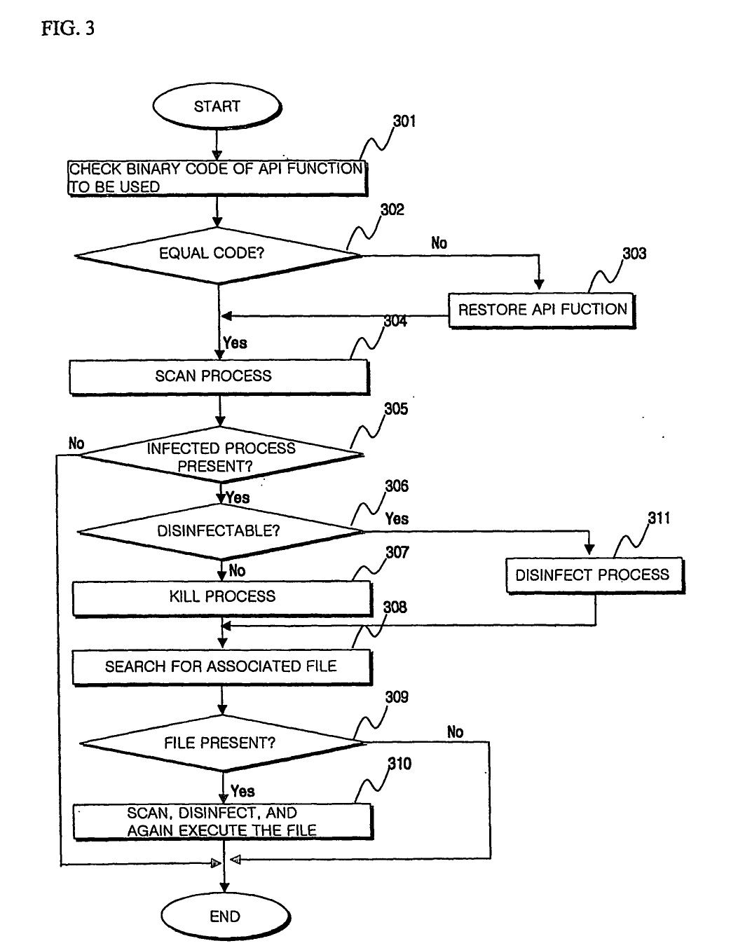

Now, the present invention will be described in more detail in conjunction with preferred embodiments of FIGS. 3 to 5. These embodiments are made only for illustrative purposes, and the present invention is not to be construed as being limited to those embodiments.

FIG. 3 is a preferred embodiment according to one aspect of the present invention. In accordance with this embodiment of the present invention, the binary code of each normal API function not infected by any virus is previously stored in the vaccine program or storage device (for example, the hard disk). At step 301, this stored code is compared with the code of a corresponding API function to be used to search information about areas infectable by viruses. When it is determined at step 302 that the compared codes are identical, that is, there is no code change in the API function, the procedure proceeds to step 304 at which it is scanned whether or not there is a process infected by viruses. On the other hand, when it is determined at step 302 that there is a code change in the API function, this code-changed API function is restored using the previously stored code (Step 303). The procedure then proceeds to step 304. At step 304, it is scanned whether or not there is an infected process residing in the memory. When it is determined at step 305 that there is an infected process, it is determined at step 306 whether or not the infected process can be disinfected. Where it is determined at step 306 that the infected process can be disinfected, a disinfection operation is carried out for the infected process at step 311. Following the disinfection operation, the file corresponding to the infected process is searched for in the storage device at step 308. On the other hand, where it is determined that the infected process cannot be disinfected, this process is killed at step 307. Thereafter, the procedure proceeds to step 308 in order to search for the file corresponding to the infected process from the storage device. When it is determined at step 309 that the file corresponding to the infected process is present in the storage device, this file is scanned and disinfected at step 310, and then again executed On the other hand, it is determined at step 309 that the file corresponding to the infected process is not present in the storage device, the procedure is ended.

In accordance with the above described procedure, it is possible to completely remove viruses infecting the memory because the integrity of the API function is secured.

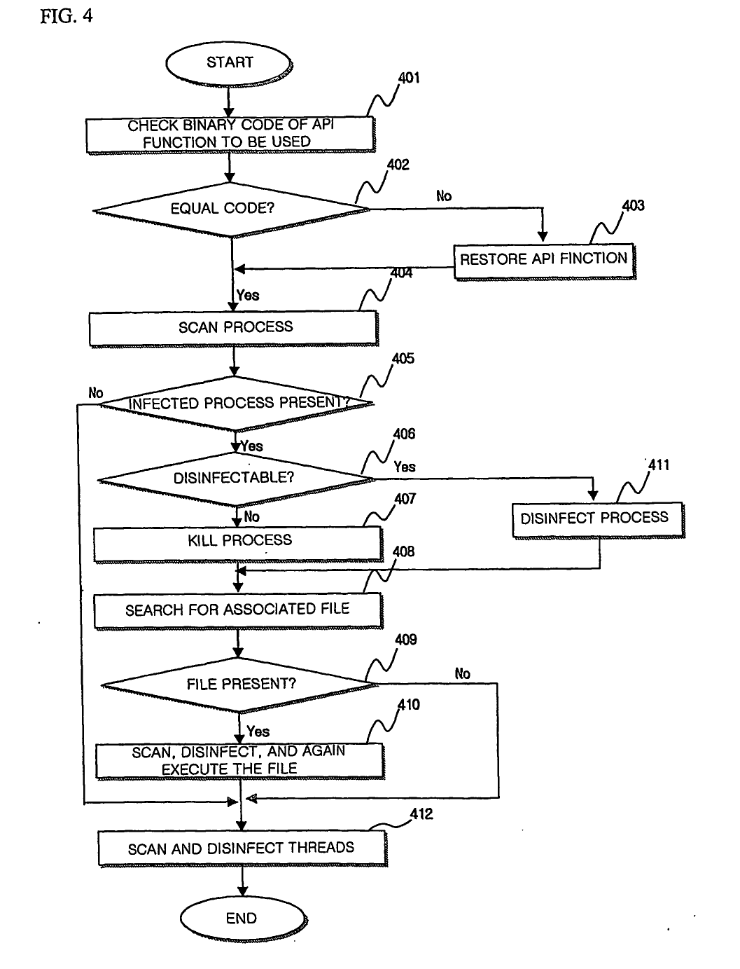

FIG. 4 is a preferred embodiment according to a second aspect of the present invention. This embodiment is different from the embodiment according to the first aspect of the present invention shown in FIG. 3 in that threads areas are scanned and disinfected. The procedure of scanning and disinfecting the thread areas of the memory in accordance with this embodiment is carried out after completion of the procedure (Step 410) for scanning, disinfecting and re-executing files (Step 412).

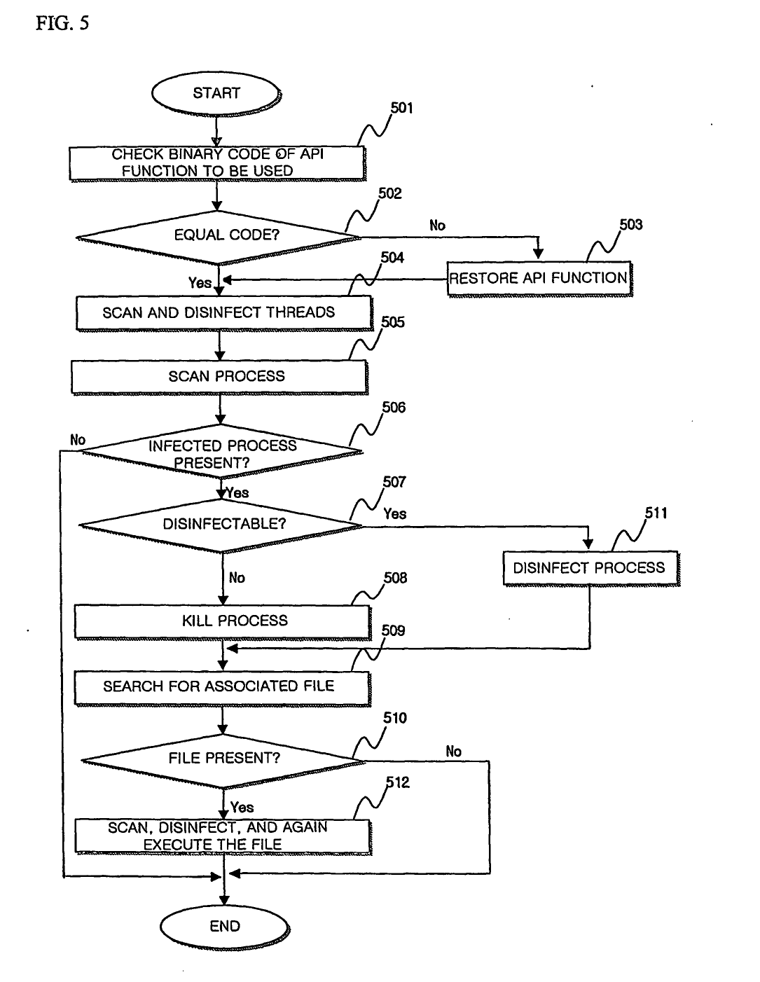

FIG. 5 is a preferred embodiment according to a third aspect of the present invention. This embodiment is different from the embodiment according to the second aspect of the present invention in that the procedure of scanning and disinfecting the thread areas of the memory is carried out prior to the procedure of scanning processes. In accordance with this embodiment, the threads areas of the memory are first scanned and disinfected at step 504. Thereafter, the processes residing in the memory are scanned at step 505 in order to check whether or not there is an infected process residing in the memory. Where it is determined at step 506 that there is an infected process, it is determined at step 507 whether or not the infected process can be disinfected. When it is determined at step 507 that the infected process can be disinfected, this process is subjected to a disinfection procedure at step 511. Subsequently, a file corresponding to the infected process is searched for in the storage device at step 509. On the other hand, where it is determined that the infected process cannot be disinfected, this process is subjected to a killing procedure at step 508. Following the killing of the infected process, step 509 is executed to search for the file corresponding to the infected process from the storage device. Where the file corresponding to the inspected process is present in the storage device, this file is subjected to a scanning and disinfecting procedure, and then again executed at step 512. On the other hand, where it is determined at step 510 that there is no corresponding file in the storage device, the vaccine program is ended.

The procedure of scanning and disinfecting thread areas in the embodiment according to the second or third aspect of the present invention can be carried out before or after the procedure of scanning and disinfecting processes.

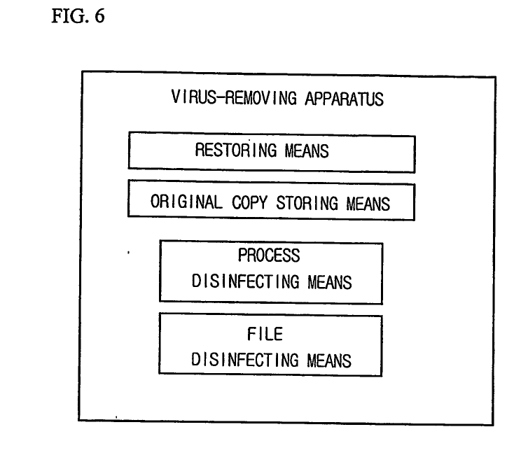

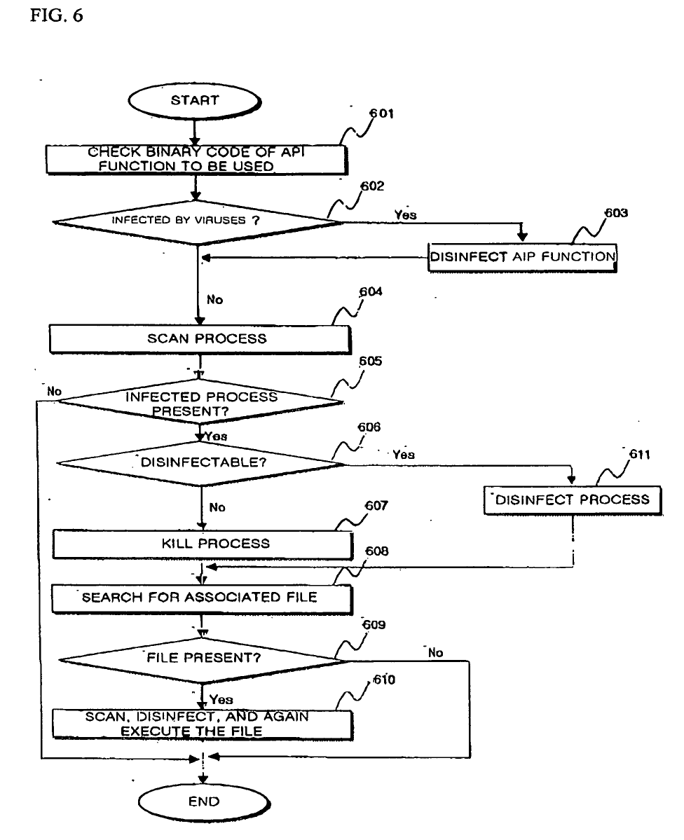

Meanwhile, in accordance with another embodiment of the present invention, a virus-removing method is implemented in a manner shown in FIG. 6. Steps 601 to 603 in FIG. 6 are different from the API function restoring procedure (Steps 301 to 303) of FIG. 3. This will be described in more detail.

When a virus infects an API function, it changes the code of the API function so that it is executed prior to execution of the API function. Also, the virus contains, in its execution code, the original code of the API function (for example, “B8 AC 00 00 00” in the case of the function “NTDLL.DLL:: NtQuerySysteminformation” used in WinXP).

If the virus does not contain such an original code, a serious system error occurs. For this reason, the virus must essentially contain the original code, in order to enable the API function to be executed after execution thereof.

In this regard, the infected API function can be disinfected by previously storing information about the position of the original code in an associated virus obtained in accordance with an analysis of an infection pattern of the virus, and restoring the changed code of the infected API function into the original code, using the stored information.

For such a disinfection, infection patterns of formalized viruses are analyzed to obtain information required for virus scanning and removal. The obtained information is then stored in a vaccine program or storage device (for example, a hard disk) so that it is subsequently used for virus scanning and removal. This information includes characteristic patterns of viruses, changed code positions, and original code positions and code lengths to be used for code recovery.

In accordance with this method, it is first checked whether or not the binary code of the API function has a pattern corresponding to the stored information (Step 601). Where the binary code of the API function has a pattern corresponding to the stored information, it is determined that the API function has been infected by a virus. When it is determined that the API function has been infected by a virus (Step 602), the infected API function is disinfected, using a code located at the position corresponding to the information (Step 603).

The subsequent procedure (Steps 604 to 661) is identical to that of steps 304 to 311 shown in FIG. 3, so that description thereof is omitted. This method may be applied, as it is, to the API function disinfecting procedure of FIG. 4 or 5. The above described disinfection procedure according to the present invention can be implemented in the form of a program which can be run in a computer system. This program can be recorded on a computer-readable storage medium so that it is executed in a general purpose digital computer system. Such a storage medium may include magnetic storage media (for example, ROMs, floppy discs, hard disks, etc.), optically-readable media (for example, CD-ROMs, DVDs, etc.), and media such as carrier waves (for example, transferring data through the Internet).

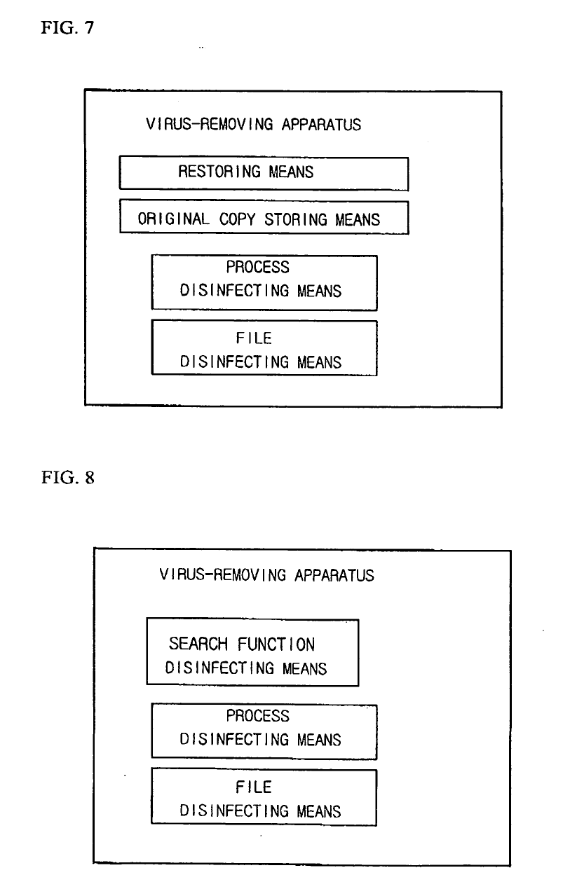

However, the present invention is not limited to such examples. The present invention can be implemented in the form of a hardware device (virus-removing apparatus) applicable to PCs, PDAs, mobile phones, semiconductor manufacturing equipment, and other industrial appliances. In this case, the virus-removing apparatus may include restoring means, process disinfecting means, and file disinfecting means, as shown in FIG. 7.

The restoring means compares the binary code of an API function adapted to search for information about areas infectable by viruses with the binary code of a corresponding API function not infected by any virus and previously stored. When it is determined that there is a code change in the compared API function, the restoring means restores the code-changed API function into its original binary code.

In this case, the virus-removing apparatus may further include original copy storing means for storing respective binary codes of API functions not infected by any virus. Preferably, the binary codes of API function are stored in association with respective operating systems.

The process disinfecting means searches for a list of processes and an entry point of each process, using an API function. The process disinfecting means scans the memory page, starting from the entry point of the associated process, thereby checking whether or not the associated process has been infected by viruses. Where the process has been infected by removable viruses, the process disinfecting means disinfects the infected process.

Where the infected process cannot be disinfected, the process disinfecting means kills the infected process. At this time, a message for confirming the killing of the infected process is preferably displayed, prior to the execution of the killing procedure, so as to allow the user to confirm the killing of the damaged process.

The file disinfecting means searches for a file corresponding to the infected process scanned by the process disinfecting means, checks whether or not the file has been infected, disinfects infected the file, and again executes the disinfected file.

Meanwhile, the virus-removing apparatus may further include thread disinfecting means for disinfecting threads. This thread disinfecting means searches for a list of threads associated with processes residing in the memory, and an entry point of each thread, using an API function. The thread disinfecting means scans the memory page, starting from the entry point of the associated thread, thereby checking whether or not the associated thread has been infected by viruses. Where the thread has been infected, the thread disinfecting means disinfects the infected thread.

The thread disinfecting means may scan and disinfect threads after the file disinfection of the file disinfecting means or before the memory-resident process searching of the process disinfecting means using an API function.

Where the method described with reference to FIG. 6 is implemented into a virus-removing apparatus, this virus-removing apparatus may include a search function disinfecting means, a process disinfecting means, and a file disinfecting means, as shown in FIG. 8. Although not shown, the virus-removing apparatus may further include a thread disinfecting means for disinfecting infected threads.

The virus-removing apparatus has information including patterns of viruses, changed code positions, and original code positions and code lengths to be used for code recovery. The search function disinfecting means checks whether or not the binary code of the API function has a pattern corresponding to the information. Where there is a characteristic patter in the API function, the API function is disinfected, using a code located at the position corresponding to the information.

The process disinfecting means, file disinfecting means, thread disinfecting means are identical to those of FIG. 7, so that description thereof is omitted.

### INDUSTRIAL APPLICABILITY

In accordance with the configuration of the present invention, it is possible to completely and accurately scan information about areas injectable by viruses, in particular, all processes residing in the memory, and to completely remove viruses infecting the memory.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

1. A method for removing computer viruses comprising the steps of:
(A) if a function to be used to search information about areas injectable by viruses has been changed, restoring the function to be in a normal state thereof; and
(B) carrying out a procedure for scanning of infection and a disinfection procedure for processes residing in a memory and associated files scanned using a normal function.

2. The method according to claim 1, wherein the normal function at the step (B) is the function determined to be unchanged, or restored using a previously-stored function when the function is determined to be changed.

3. The method according to claim 1, wherein the step (B) comprises the steps of:
scanning a process residing in the memory;
determining whether or not the infected process is disinfectable, and disinfecting the process when it is determined that the infected process is disinfectable, while killing the process when it is determined that the infected process cannot be disinfected; and
searching for a file associated with the infected process, and scanning and disinfecting the searched file.

4. The method according to claim 1, wherein the procedure for scanning of infection and the disinfection procedure are further carried out for thread areas of the memory.

5. The method according to claim 4, wherein the step (B) comprises the steps of:
scanning a process residing in the memory;
determining whether or not the infected process is disinfectable, and disinfecting the process when it is determined that the infected process is disinfectable, while killing the process when it is determined that the infected process cannot be disinfected;
searching for a file associated with the process, and scanning and disinfecting the searched file; and
scanning and disinfecting the thread areas of the memory.

6. The method according to claim 4, wherein the step (B) comprises the steps of:
scanning and disinfecting the thread areas of the memory;
scanning a process residing in the memory;
determining whether or not the infected process is disinfectable, and disinfecting the process when it is determined that the infected process is disinfectable, while killing the process when it is determined that the infected process cannot be disinfected; and
searching for a file associated with the process, and scanning and disinfecting the searched file.

7. The method according to claim 1, wherein the function is provided by DOS, Macintosh, Windows, OS/2, Unix, or Linux.

8. The method according to claim 1, wherein the function is an application program interface (API) function or a system call.

9. A computer-readable storage medium recorded with a program for executing the steps of:
(A) if a function to be used to search information about areas infectable by viruses has been changed, restoring the function to be in a normal state thereof; and
(B) carrying out a procedure for scanning of infection and a disinfection procedure for processes residing in a memory and associated files scanned using a normal function.

10. The computer-readable storage medium according to claim 9, wherein the normal function at the step (B) is the function determined to be unchanged, or restored using a previously-stored function when the function is determined to be changed.

11. The computer-readable storage medium according to claim 9, wherein the step (B) comprises the steps of:
scanning a process residing in the memory;
determining whether or not the infected process is disinfectable, and disinfecting the process when it is determined that the infected process is disinfectable, while killing the process when it is determined that the process cannot be disinfected; and
searching for a file associated with the infected process, and scanning and disinfecting the searched file.

12. The computer-readable storage medium according to claim 9, wherein the procedure for scanning of infection and the disinfection procedure are further carried out for thread areas of the memory.

13. The computer-readable storage medium according to claim 12, wherein the step (B) comprises the steps of:
scanning a process residing in the memory;
determining whether or not the infected process is disinfectable, and disinfecting the process when it is determined that the infected process is disinfectable, while killing the process when it is determined that the infected process cannot be disinfected;
searching for a file associated with the infected process, and scanning and disinfecting the searched file; and
scanning and disinfecting the thread areas of the memory.

14. The computer-readable storage medium according to claim 12, wherein the step (B) comprises the steps of:
scanning and disinfecting the thread areas of the memory;
scanning a process residing in the memory;
determining whether or not the infected process is disinfectable, and disinfecting the process when it is determined that the infected process is disinfectable, while killing the process when it is determined that the infected process cannot be disinfected; and
searching for a file associated with the process, and scanning and disinfecting the searched file.

15. The computer-readable storage medium according to claim 9, wherein the function is an application program interface (API) function or a system call.

16. A virus-removing apparatus comprising:
restoring means for restoring a function to be used to search information about areas injectable by viruses when the function has been changed;
process disinfecting means for searching for a list of processes residing in a memory by use of the function in a normal state, and an entry point of each of the process, scanning a memory page, starting from the entry point of an associated one of the processes, thereby checking whether or not the associated process is infected by viruses, the process disinfecting means carrying out a procedure for disinfecting the associated process when the associated process has been infected; and
file disinfecting means for searching for a file associated with each of the infected processes, scanning and disinfecting the searched file.

17. The virus-removing apparatus according to claim 16, further comprising:
thread disinfecting means for scanning and disinfecting thread areas of the memory.

18. The virus-removing apparatus according to claim 16, wherein the function is provided by DOS, Macintosh, Windows, OS/2, Unix, or Linux.

19. The virus-removing apparatus according to claim 16, wherein the function is an application program interface (API) function or a system call.

20. The virus-removing apparatus according to claim 16, wherein the virus-removing apparatus is a hardware device applied to a personal computer (PC), a personal digital assistant (PDA), a mobile phone, and industrial equipment including semiconductor manufacturing equipment.
